(19) United States
(12) Patent Application Publication
(10) Pub. No.: US 2014/0344874 A1
(43) Pub. Date: Nov. 20, 2014

(54) METHOD OF NETWORK NODE PERFORMANCE RANKING

(71) Applicant: JDS Uniphase Corporation, Milpitas, CA (US)

(72) Inventor: Eric OLSEN, Thorton, CO (US)

(73) Assignee: JDS Uniphase Corporation, Milpitas, CA (US)

(21) Appl. No.: 14/280,407

(22) Filed: May 16, 2014

Related U.S. Application Data
(60) Provisional application No. 61/824,795, filed on May 17, 2013.

(51) Int. Cl. H04N 17/00

(52) U.S. Cl. CPC H04N 17/004
USPC 725/107

(57) ABSTRACT

The invention relates to a method of determining maintenance priority for different portions of a CATV network. By calculating a health score for each node of the network based on a plurality of measurements performed downstream from the nodes, the nodes and the downstream segments of the network may be ranked according to their health score values, and the maintenance of the network segments may be prioritized based on the health ranking of the corresponding nodes. The health score for a node may be computed based on a plurality of tilt- and modulation-normalized frequency scans of the network signal.

### CROSS-REFERENCE TO RELATED APPLICATIONS

The present invention claims priority from U.S. Provisional Patent Application No. 61/824,795 filed May 17, 2013, entitled “Method to rank HFC CATV nodes”, which is incorporated herein by reference.

### TECHNICAL FIELD

The present invention generally relates to testing and monitoring of communication networks, and more particularly relates to systems and methods for testing, evaluating and ranking nodes of a cable TV network.

### BACKGROUND OF THE INVENTION

Cable TeleVision (CATV) systems typically utilize two-way hybrid fiber-coaxial (HFC) cable networks, which are shared bi-directional networks with point-to-multipoint transmission in the downstream direction using a mix of analog and digital signals, and multipoint-to-point transmission in the upstream direction. Signals are distributed via a fiber optic connection from a head-end to a node that converts the optical signal to an electrical signal, and then distributes the signals to residences via a tree and branch coaxial cable distribution network. At the subscriber side, terminal equipment supports the delivery of cable services (video, data and voice services) to subscribers, via cable modems. Data and voice services are supported by cable modems and communication gateways, respectively, which require the use of an upstream signal path. The network typically uses a fiber optic upstream signal path from the node to the head-end. A return band is used to support transmissions from devices at subscribers' premises back to the head-end. In such networks, many cable modems may compete for communication bandwidth in both the upstream and downstream directions.

Delivery of data services over cable networks, and in particular cable television (CATV) networks, is typically compliant with a Data Over Cable Service Interface Specifications (DOCSIS®) standard. The term ‘DOCSIS’ generally refers to a group of specifications published by CableLabs that define industry standards for cable headend equipment, such as Cable Modem Termination System (CMTS), and cable modem (CM) equipment. Subscribers send data from their digital devices, such as personal computers (PC), VoIP phones, Video IP devices, etc, into the CM, which then relays the data to the CMTS, which in turn relays the information to an appropriate network element. Information destined to the subscriber digital device is provided from the network to the CMTS, which in turn relays the information to the CM. The CM in turn relays the information to the subscriber's digital device. The communication direction from the CMTS to the CM is referred to as the downstream direction, while the communication direction from the CM to the CMTS is referred to as the upstream direction.

An ability to test the performance of the cable network equipment installed in the field, including at the HFC nodes, and to maintain it at a desired high level without customer service interruptions is essential for the cable network operation. Portable network testing devices, such as for example JDSU's Digital Services Activation Meter DSAM™, can generate a specialized spectrum scan of a network using specialized testing methods, such as that disclosed in U.S. Pat. No. 8,345,737, which is incorporated herein by reference. The method described in that patent produces a tilt normalized, modulation-corrected scan of the HFC plant and is usually run at the HFC tap node near a customer's premise. The spectrum scan data is saved in a non-volatile memory on the testing device, and may be transferred to a network-connected test data storage where it is saved in non-volatile memory that is accessible by a network test controller or server, either remotely via a suitable network or in direct connection.

An object of the present invention is to provide a method and system for ranking the performance of HFC tap nodes using tilt normalized and modulation-corrected spectrum scan data measured by network testing devices in the field.

### SUMMARY OF THE INVENTION

Accordingly, one aspect of the present invention relates to a method of determining maintenance priority for different portions of a CATV network. By calculating a health score for each node of the network based on a plurality of measurements performed downstream from the nodes, the nodes and the downstream segments of the network may be ranked according to their health score values, and the maintenance of the network segments may be prioritized based on the health ranking of the corresponding nodes.

The present invention also relates to a method of ranking the nodes of a network based on a historical record of modulation-corrected and tilt-corrected spectral scan data collected at different locations in the network served by different nodes, and based on a set of signal health indicators derived from the spectral scan data.

One aspect of the present invention relates to a method for evaluating a node performance in a network, the method comprising: a) measuring a network signal provided by the node and collecting spectral scan data therefore; b) computing a set of signal health indicators from the collected spectral scan data; c) comparing each signal health indicator to one or more predetermined threshold values; and, d) computing a test score based on the set of signal health indicators for the node to evaluate the node performance at the time of the measurement. In according to one aspect of the invention, the set of signal health indicators may comprise maximum and minimum deviations of a tilt-normalized channel power from a desired value and a tilt compensation value.

One aspect of the present invention further includes computing health scores for the nodes based on a plurality of the test scores obtained for each of the nodes over a selected time interval, and then ranking then nodes by comparing the test scores to determine a node maintenance priority.

### BRIEF DESCRIPTION OF THE DRAWINGS

The invention will be described in greater detail with reference to the accompanying drawings which represent preferred embodiments thereof, in which like elements are indicated with like reference numerals, and wherein:

FIG. 1 is a schematic block diagram of a CATV HFC network;

FIG. 2 is a schematic block diagram of a CATV tester;

FIG. 3 is a flowchart of the process of evaluating the performance of a node of the CATV network;

FIG. 4 is a schematic block diagram of a central network controller hosting a test database;

FIG. 5 is a flowchart of a method of network node health ranking;

FIG. 6 is a graph illustrating an exemplary modulation-corrected spectral scan data and the definition of several signal health indicators related thereto;

FIG. 7 is flowchart illustrating a process of determining a node health score.

### DETAILED DESCRIPTION

In the following description, for purposes of explanation and not limitation, specific details are set forth, such as particular circuits, circuit components, techniques, etc. in order to provide a thorough understanding of the present invention. However, it will be apparent to one skilled in the art that the present invention may be practiced in other embodiments that depart from these specific details. In other instances, detailed descriptions of well-known methods, devices, and circuits are omitted so as not to obscure the description of the present invention.

Note that as used herein, the terms “first”, “second” and so forth are not intended to imply sequential ordering, but rather are intended to distinguish one element from another unless explicitly stated.

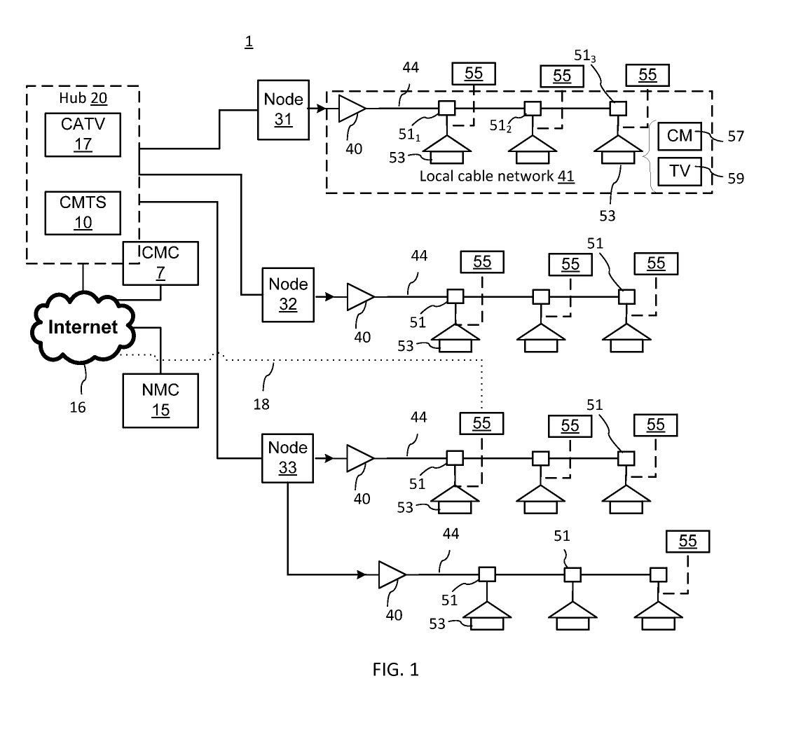

With reference to FIG. 1, there is shown a schematic block diagram of an exemplary HFC network 1 including features of the present invention. HFC networks are commonly implemented to deliver Cable Television (CATV) signals, including analog TV signals and digital TV signals, as well as data and control signals, to customer, i.e. subscriber of CATV services, premises such as a home or a business. In the HFC network 1, which is also referred to herein as cable network 1, data services are provided using a DOCSIS transceiver 10, which is commonly referred to as a Cable Modem Termination System (CMTS). As shown, the CMTS 10 is located at a regional network hub 20, as known in the art. TV services are provided using CATV transmitters 17, which may include digital TV (DTV) transmitters and analog TV transmitters. CMTS 10 transmits RF-modulated downstream signals carrying data over a plurality of downstream channels allocated for data services, for example as defined by DOCSIS, while CATV transmitters 17 transmit digital and/or analog TV signals in a plurality of TV channels, which generally do not overlap in frequency with the DOCSIS channels. In the context of this specification, the terms ‘CATV channels’ and ‘CATV signals’ are used interchangeably and include digital TV channels or signals, analog TV channels or signals and data channels of signals, including DOCSIS signals or channels. All these signals are distributed from the hub 20 through local multiplexers (MUX) or nodes 31-33 using first optical fibers and then coaxial cables to a plurality of CATV devices such as TV receivers 59 and cable modems (CMs) 57 located at customer, i.e. subscriber, premises 53. The HFC network 1 would typically serve a large number of customer premises 53 connected to a plurality of different cable trunks 44 at a plurality of different locations. The CMTS 10 may be located in an optical portion of the network, in which case the RF signals it generates are first converted to optical signals using laser transmitters at the hub 20 and then delivered over optical fiber to the nodes 31-33. At the nodes the downstream and upstream signals may undergo optical-to-electrical (OE) and electrical-to-optical (EO)) conversion as known in the art, in which case they may be referred to as the OEO nodes; see for example US Patent Application 2007/0133425, which is incorporated herein by reference. Each of the OEO nodes 31-33 supports a local cable network, such as the local cable network 41, which provides CATV services to end-of-the-line subscribers 53. The downstream RF signals generated by the nodes 31-33, which carry analog and digital CATV channels, are distributed to a plurality of end-of-the-line subscribers 53 via one or more trunk cables 44 and CATV taps 51, which are also referred to herein as subscriber taps or nodes. One or more two-way trunk RF amplifiers 40 may further be provided in each trunk cable to suitably amplify the upstream and downstream CATV signals on their way to and from the subscriber premises 53.

A central measurement controller (CMC) 7, which is also referred to herein as the test server, may be provided for storing network measurement results collected from the cable plant. In some embodiments, the CMC 7 may connect to the CMTS 10 via a TCP/IP network 16 using Internet Protocol (IP), and may or may not be co-located with the CMTS 10. In other embodiments, CMC 7 may be in the form of a suitable computing device, for example a PC, that is connected to the TCP/IP network 16 at a remote location, such as a data center, and receives network test data directly from testers 55 over the TCP/IP network 16 without going through CMTS 10. Note that the TCP/IP network 16 is a logical network that may or may not utilize the physical infrastructure of the HFC network 1. A network management controller (NMC) 15 may collect the measurement results from CMC 7, process them and rank the network nodes according to their performance. NMC 15 may connect to the CMC 7 remotely, for example via the TCP/IP network 16, or may be co-located with the CMC 7. NMC 15 may be, for example, in the form of a personal computer, a server computer, a portable computing device or the like that is connected to the network and is running network management software, as generally known in the art. In some embodiments of the present disclosure, NMC 15 is programmed to perform one or more steps of a method of the present disclosure described hereinbelow for ranking nodes of the HFC network 1. The CMC 7 and the NMC 15 may be referred to collectively as the test server, and may be embodied using a single computing device or using separate computing devices.

Performance of various sections of the HFC network 1, such as the local cable networks 41 and nodes 31-33 feeding them, may be assessed using various network test instruments for measuring parameters representing the quality of a CATV signal in the CATV coax cable plant, which are referred to herein as signal health indicators, signal indicators, or simply as indicators. The network test instruments that may be used include but are not limited to portable network signal testers 55, which may be connected to the cable plant at various locations in the network and are typically used by a technician in the field at service activation or to investigate a reported problem, such as the Digital Services Activation Meter DSAM™ that is available from JDSU. The testers 55 may transmit test results to CMC 7, for example via a return DOCSIS channel, or using an alternative TCP/IP connection as schematically shown by a dotted line 18, for example using a wireless, such as cellular, network.

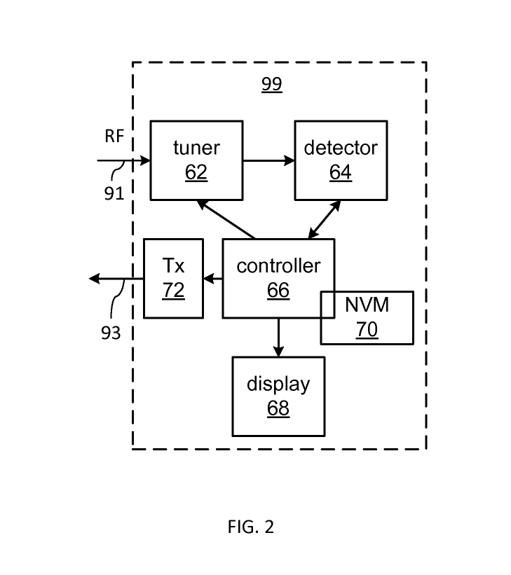

With reference to FIG. 2, there is illustrated a schematic block diagram of an exemplary CATV signal testing device 99 which can be used as the network signal tester 55. The tester 99 includes a controller 66, a radio frequency (RF) tuner 62 connected to the controller 66, a detector 64 connected to both the controller and the tuner, and a display 68 connected to the controller. The RF tuner 62 connects to the CATV network 1 at a desired location to receive the CATV signal 91 therefrom, and is capable of tuning to any channel being broadcast on the CATV network. The detector 64 may include one or more appropriate detectors for measuring power of either analog TV channels and/or digital channels. The controller 66 may include non-volatile memory 70 for storing an operating program, configuration data and measurement results. In one embodiment, the controller 66 is configured, i.e. programmed, to control the operation of the tuner 62 and the detector 64 to scan the CATV spectrum, or any selected portion thereof, and to collect spectral scan measurement data. The display 68 may be as simple as an indicator light or as elaborate as a touch screen for configuring the device, selecting channels, and reporting measurement progress and results. The tester 99 may further include a transmitter 72 for transmitting measurement results 93 to the central controller 7, for example over the HFC network 1 in an upstream DOCSIS channel, or over a TCP/IP connection.

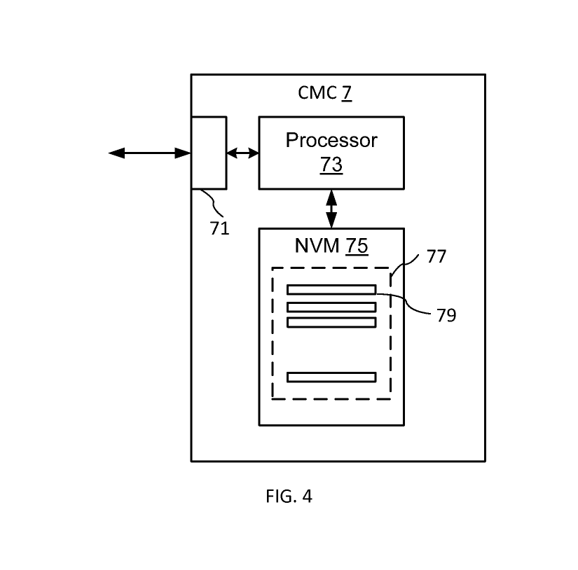

With reference to FIG. 4, test results generated by the tester 99 are transmitted to CMC 7, which in one embodiment includes a network interface 71, a processor 73, and a non-volatile memory (NVM) 75, and which maintains a network test results database 77 containing historical records of the tests 79 in the NVM 75. The network interface 71 may include a coaxial cable interface when CMC 7 is co-located with the CMTS 10, and/or an Ethernet card for connecting to a TCP/IP network, a wireless network card, or any suitable network interface as known in the art.

One important source of service impairments is intermodulation distortion (IM). The IM is generated within the receiver of customer premises equipment (CPE), such as a CATV digital receiver, when adverse signal conditions are present. Such adverse signal conditions may include, for example, too much or too little power relative to the desired signal at frequencies above and/or below the frequency band containing the desired signal. U.S. Pat. No. 8,345,737, which is incorporated herein by reference, discloses a method for detecting network impairments through tilt-normalized and modulation-normalized spectral scan data, and generating one or more signal indicators that characterize the signal quality at the location of the measurement.

Conventionally, the signal quality measurements, such as those described in '737 patent or the like, are performed at the time of customer service activation, or to analyze a reported network problem. On the other hand, routine preventive maintenance of HFC plant and replacement of network equipment at the nodes is typically performed at scheduled intervals, except when necessitated by a failure. In contrast, the present disclosure provides a method to rank network nodes according to their ‘health’, so that nodes that are still functioning but have a relatively lower ‘health ranking’ and thus are suspect of having problems are identified and can be repaired ahead of nodes with relatively higher health scores.

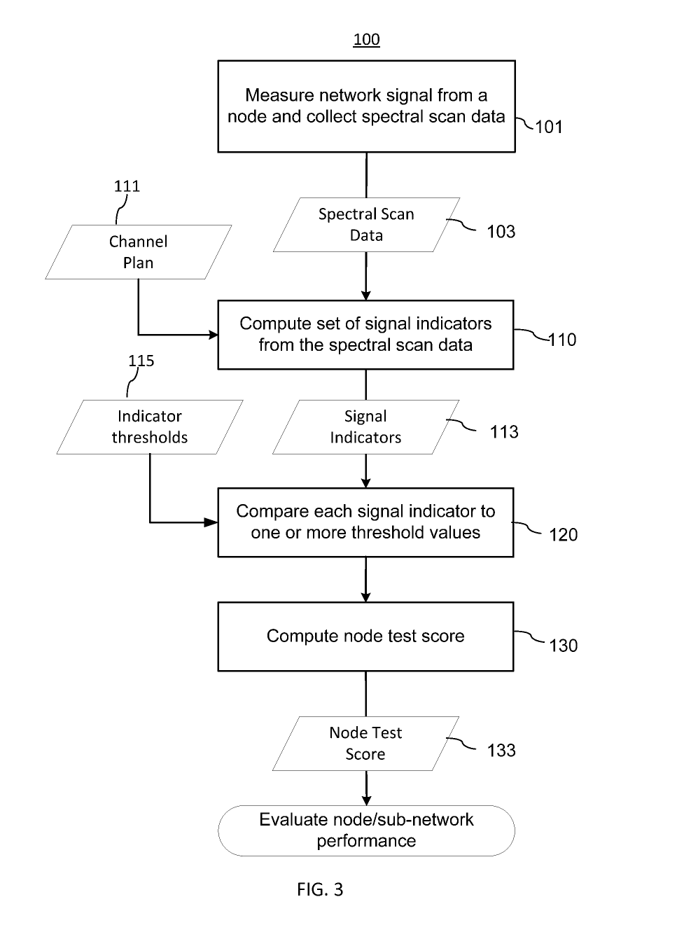

Turning now to FIG. 3, there is illustrated a flowchart of a method 100 for evaluating and ranking the performance of a CATV node in accordance with one embodiment of the present disclosure. At step 101, a network signal from a CATV node is measured, for example by the tester 99, and spectral scan data 103 is generated, for example as described in U.S. Pat. No. 8,345,737, and saved in memory 70. In one embodiment, this step may include connecting the CATV tester 99 to the network at one of the taps 51 or at the subscriber premises 53. At step 110 a set of signal quality indicators 113 is computed based on the spectral scan data 103, for example by the tester controller 66 running computer executable instructions saved in memory 70, and are also saved in the memory. The signal quality indicators 113 are also referred to as the signal health indicators. In one embodiment, these indicators may be computed based only on a subset of CATV channels that are active at the location of the measurement, as defined by a channel plan 111, and as described more in detail hereinbelow. At step 120, one or more of the signal health indicators 113 is compared to one or more indicator thresholds 115 defined for the respective indicators, and at step 130 a test score (TS) TS(node#) 133 is computed based on results of the comparisons performed at step 120. Here, ‘node#’ is an identifier of CATV node, such as one of the modes 31-33 in FIG. 1, which generates the CATV signal being measured. The test score TS(node#) characterizes the cable plant fed from that node at the time and location of the measurement, and may or may not relate to the quality of the CATV signal as generated by the node itself. In one embodiment, step 120 may include computing an indicator score for the one or more of the signal indicators obtained in step 110, and step 130 may include computing the TS for the node from the totality of the indicator scores computed in step 120, for example by summing the individual indicator scores, averaging, and the like.

By way of example, in one embodiment an indicator score may be compared to an expected range of values for the indicator, and if the computed indicator score exceeds expectations, e.g. is within the desired range, the indicator is assigned a perfect score, e.g. of 100. If the indicator value found in the outside the range of expected values, the indicator would receive a lower score, for example from 15 to 35. If the indicator value is found in the middle of the expected range, an average score, for example between 35 to 65, is assigned to the indicator. Indicator results in the upper range of the expected range would receive higher scores, for example 65 to 95. NWS 133 for the node may then be computed by summing or averaging the individual indicator scores. In another embodiment, each indicator may be assigned a ‘pass’ or ‘fail’ score depending on whether the measured or computed indicator value is within a pre-defined desired range for the indicator, and the overall TS 133 is computed based on the number of ‘fails’ for the node. In one embalmment, a plurality of ranges may be defined for a signal indicator, and the signal indicator is assigned a score value in dependence upon in which of the ranges the computed value of the indicator falls.

In one embodiment, all or some of the steps 110-130 may be performed by the tester controller 66, and the results are transmitted to CMC 7. For example, in one embodiment the tester controller 66 computes the test score 133, and transmits it to CMC 7 for storing in the test database 77 as a part of the test record 79. In one embodiment, the tester 99 transmits the spectrum scan data 103, that may be averaged over several spectral scan measurements and/or modulation- and tilt-normalized, to the CMC 7 for storing therein, and steps 110-130 are performed by CMC 7. In one embodiment, the tester 99 transmits the spectrum scan data 103 to the CMC 7 for storing therein, and steps 110-130 are performed by NMC 15, which may remotely read the spectrum scan data 103 for the node that are saved at CMC 7 within the test record 79.

In order to determine a health score (HS) for a particular node and the cable plant fed by the node, multiple tests using the method 100 are carried out at different locations of the local cable network 41 that is served by the node, each test resulting in a particular value TS(node#, t) of the test score 133, where ‘t’ is a test identifier, such as an integer test counter or a value indicating the time of the test. The plurality of the test scores 133 for the node ‘node#’, for example node 31 of HFC network 1 of FIG. 1, are then combined to obtain the health score for that node HS(node#).

For example, in one embodiment a health score for the node 31 can be computed from multiple tests 100 carried out over a period of time, for example within the last 6 months, by connecting tester 99 at tap node 51₁, for example at the subscriber side thereof. In one embodiment, TS values for node 31 obtained by carrying out test 100 at different tap nodes 51₁, 51₂, and/or 51₃ over a period of time may be combined to calculate the node health score HS(node#) for the node 31.

Similarly, node health scores HS(node#) may be computed for other nodes in the CATV network 1, such as nodes 31 and 33, by performing network signal measurements in the cable network served by the node. The nodes 31-33 then may be ranked according to their health cores HS(node#) to determine the order in which maintenance of the nodes is to be performed, so that for example maintenance operations on the node with the lowest health score HS will be performed ahead of other nodes having higher health scores. In some embodiments, the health scores HS may also be computed for the tap nodes 51, such as the tap nodes 51₁, 51₂, and/or 51₃ of the local cable network 41, and the tap nodes 51 ranked according to their health.

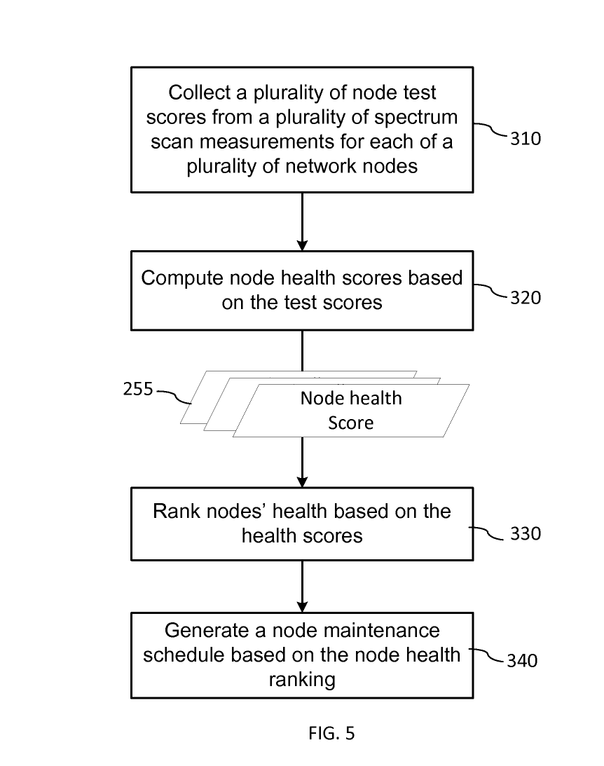

Turning now to FIG. 5, accordingly one embodiment of the invention provides a method of ranking the nodes of a CATV network that may include the following general steps: a) at 310, collecting a plurality of test scores from a plurality of spectrum scan measurements taken over a period of time for each of a plurality of network nodes which health is to be monitored; b) at 320, computing a node health score HS 255 for each of the nodes based on the wellness scores 130 for the corresponding node; and, c) at 330, rank the nodes' health based on their health scores. An embodiment of the method may further include generating a node maintenance schedule based on the node health ranking, which may include updating, i.e. changing, maintenance priority for one or more segments of the network according to the node health ranking or a change therein.

It will be appreciated that the health score HS(node#) for node ‘node#’ depends not only on the performance of the equipment of the node itself, but also on the cable plant from the node to the location of the measurement. Accordingly, the terms ‘node maintenance’ and ‘node maintenance priority’ may refer to maintenance of the equipment of the node itself and the cable plant fed from the node. In many instances when the health score HS(node#) for the node is low it may be not the node itself that is in need of repair or maintenance, but it's the outside plant fed from the node, for example between the node 31 and the particular customer premises 53 where the measurements were performed, as it is more likely to degenerate over time as it is subject to damage from weather, rodents, and other causes. Accordingly, in the context of this specification the term “node health” relates to the performance of a segment of the network that is fed from a particular node, including the equipment of the node itself and the cable plant, including equipment such as taps 51, of the local cable network 44 that is served by the node. In this way, the HFC network 1 is segmented such that a problem in one “node”, i.e. one network segment including a node and a local network 44 fed therefrom, does not affect customers that receiver CATV signals from other nodes. As the outside cable plant serving a city or a region degenerates over time, the method of the present discourse enables to divide it in network segments according to the associated nodes that feed them, analyze the network “node by node”, or segment by segment, to determine areas that are in need of work, and prioritize their maintenance. For example, a low health score obtained from a totality of the tests saved for a node is indicative of the quality of the plant fed from that node. It's possible that certain portions of the network segment 44 fed from the node are in good operating condition while other portions are not. Thus a node that feeds the cable plant that is working well in all its parts will have a high health score and therefore may be excluded from routine maintenance, or its maintenance priority is downgraded. Nodes with a low overall health score 255 may be scheduled for maintenance as soon as possible. A node health score 255 that is neutral may indicate that portions of the associated local network segment 44 are working well, but other portions may not and therefore its maintenance may be prioritized accordingly.

In one embodiment, step 330 of ranking of the nodes' health may include ordering the nodes in an ascending or descending order of their health scores 255, which may also indicate a preferred order in which their maintenance is to be performed. In one embodiment, this step may include grouping the nodes in a plurality of categories according to their health scores, in accordance with pre-deified HS ranges. By way of example, for a maximum HS value of 100, nodes with a health score less than 25 may be categorized as ‘suspect’, nodes with a health score in the range of 25 to 75 may be categorized as ‘mixed’, and nodes with a health score greater than 75 may be categorized as ‘flat.’ It will be appreciated that other pre-determined threshold levels, number of categories and their names are within the scope of the present invention.

In one embodiment, the tester 99 performs the tilt and modulation normalized spectral scan, such as that described in detail in U.S. Pat. No. 8,345,737, which is incorporated herein by reference. In this embodiment, the tester 99 is first connected to the cable network downstream from one of the nodes, for example node 31 in HFC network 1, such as at one of the CATV taps 51₁-51₃, and then the tester may perform a scan of the full spectrum of the CATV signals that may be present downstream from the node. In one embodiment that may include using the channel plan 111 for the node or for the particular subscriber to determine RF frequencies at which the RF power is to be measured. The channel plan 111 may include a description of the channels being transmitted on the cable, including frequency and modulation type. For example, one method of measuring the digital channel power is known in the art as Digicheck. Another less accurate method is to measure the power at the center frequency of the selected channel and add a bandwidth compensation factor based on the ratio of digital channel bandwidth to measurement bandwidth. The power measurements may be performed periodically in order to update the display with current results. The channel power measurements may include measuring the power of all or a subset of the channels being transmitted. For example, only those channels that could substantially contribute to intermodulation distortion may be selected for measurements.

The measured channels could include video carriers of the analog TV channels, for example, since they normally have the highest power. In one embodiment, the tester may take into account the existence of the power level offset between channels of different modulation type. For example, analog TV channels are typically transmitted at a higher power level than digital TV channels. Furthermore, DTV channels may utilize QAM modulation of different orders, which may also be transmitted at different power levels. Hence, in one embodiment the tester 99 normalizes the measured powers of the CATV channels by removing the modulation type related level offsets. For example, if the transmission power of an analog TV channel is known to be 6 dBmV higher than that of the DTV channels, the tester controller 66 would subtract 6 dBmV from the measured powers of the analog channels to obtain a modulation-corrected power P_{corr}(channel#) for the measured channel.

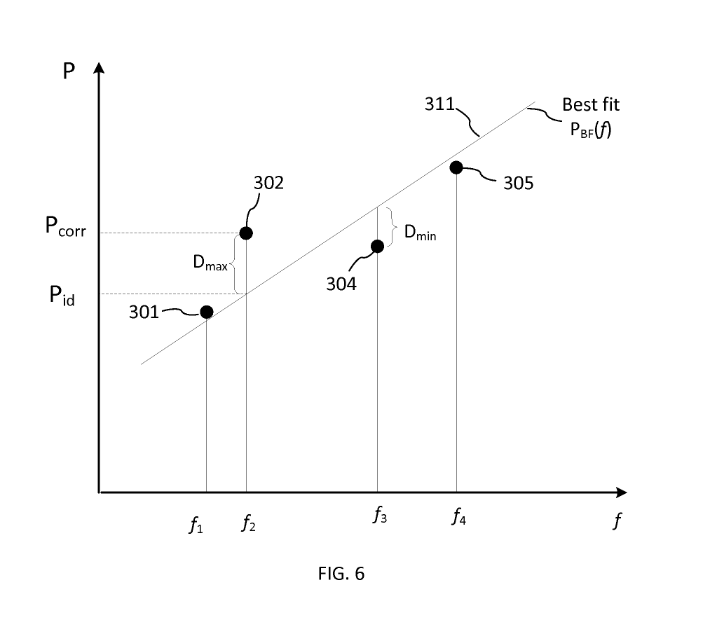

Next, the tester 99 may perform a tilt-normalization of the measured modulation-corrected channel powers. This process may be explained by way of example with reference to FIG. 6, which shows an exemplary spectral scan plot wherein modulation-corrected powers of four active channels at frequencies f₁ to f₄ are shown as black dots labeled 301 to 305. Although only four channels are illustrated by way of example, a real-life plot of a CATV frequency scan will typically include a greater number of channels, which may be numbered in tens or even hundreds. Several approaches may be used to estimate a tilt in the measured channel spectrum, as represented by a tilt line 311 in FIG. 6, some of which described in U.S. Pat. No. 8,345,737. For example, in one embodiment the tilt line 311 is a best linear fit function P_{BF}(f) to the measured or modulation-corrected spectrum scan data, which is computed using one of the known in the art best-fit algorithms. The tilt-normalization of the spectrum may then include subtracting the tilt line, for example the best linear fit function P_{BF}(f), from the measured or modulation-normalized power spectrum P(f) of the RF signal being measured.

In one embodiment, the test controller computes a maximum deviation Dmax and a minimum deviation Dmin, for example according to equations

Dmax=MAX{Pcorr(fᵢ)−P_{BF}(fᵢ}|_{i=1, . . . , N} (1)

Dmin=MIN{Pcorr(fᵢ)−P_{BF}(fᵢ)}|_{i=1, . . . , N} (2)

That is, the maximum deviation indicator Dmax is a maximum difference between the modulation-corrected measured value Pcorr(fᵢ) of a channel power and its ‘ideal’, or tilt-corrected, value P_{BF}(fᵢ) of the channel power as defined by the tilt line 311, where the maximum is taken over all measured active channels. Similarly, the minimum deviation indicator Dmin is a maximum negative difference between the modulation-corrected measured value of a channel power and its ‘ideal’, or tilt-corrected, value of the channel power as defined by the tilt line 311. FIG. 6 illustrates both Dmin and Dmax for the simplified exemplary spectrum shown therein.

Referring back to FIG. 3, in one embodiment of method 100 the signal health indicators that are computed in step 110 are Dmin and Dmax, which may be measured for example in dB, and the tilt ‘TC’ of the tilt line 311, which can be measured, for example, in dB per a unit of the RF frequency change, for example 100 MHz. In one embodiment, the controller further computes a fourth signal health indicator in the form of an overall ‘peak-to-valley’ difference P2V, which is the difference between the maximum deviation Dmax and the minimum deviation Dmin:

P2V=Dmax−Dmin (3)

In one embodiment, the tester 55 or 99 is provided with the channel plan 111 for the subscriber tap 51 where the spectral scan measurements are performed to define which channels are in use for that CATV system and/or paid for by the customer. After performing some or all of the steps of the test 100 as described hereinabove, the tester 55 transmits the spectrum scan data 103 and/or the set of indicators 113, for example Dmin, Dmax, TC, and, optionally, P2V, to CMC 7 for saving in the network test results database 77 as a test record 79, along with additional measurement related data, such as the channel plan, the location of the test, the date of the measurement, and the node identifier ‘node#’ of the node feeding the local network where the measurement was performed. In one embodiment, the tester 55 may further compute the test score TS 133 for the test based on the set of signal indicators 113, and send it to CMC 7 for saving with the test record 79.

By way of example, the test score may be computed by comparing the measured values of the signal health indicators Dmin, Dmax, TC and P2V to their pre-defined respective threshold values Dmin_Thr, Dmax_Thr, TC_Thr and P2V_Thr, so that when one of the indicators, or an absolute value thereof, exceeds the corresponding threshold value, the respective indicator is identified as a ‘fail’, and as a ‘pass’ otherwise. The test score TS may then be computed by subtracting (TSmax/N_{ind}) from a pre-defined maximum possible value TSmax of the TS, for example 100. Here, N_{ind} is the number of the signal health indicators that are used in computing the TS, or N_{ind}=4 in the current example. For example, if TSmax=100, TS=75 when only one of the indicators Dmin, Dmax, TC and P2V exceeds its threshold, i.e. is out of the desired range, TS=25 when three of the indicators Dmin, Dmax, TC and P2V exceed their corresponding thresholds, i.e. are outside of their respective desired ranges, TS=0 when all four of the indicators Dmin, Dmax, TC and P2V exceed their corresponding thresholds, and TS=100 when all four of the indicators Dmin, Dmax, TC and P2V are below their corresponding threshold values Dmin_Thr, Dmax_Thr, TC_Thr and P2V_Thr, respectively, i.e. are within their respective desired ranges.

When computing the node health score HS(node#), NMC 15 would read all test records for the node from the network test database stored by CMC 7, and use the respective test scores TS(node#) obtained based on the recorded tests to generate the node health score HS(node#).

In one embodiment, only those channels that are defined in the channel plan 111 are measured by the tester 55 in order to exclude false ‘fail’ results for those of the CATV channels that are not provided at the location of the measurement.

By way of example, if a customer which CATV signal is being measured is only paying for high-speed data service, the network operator will filter out at the subscriber tap 51 all the video channels going into the customer premises 53 to prevent the customer from getting the unpaid channels. However, if a test is run in the home of that customer using all “regular” CATV channels, the test would fail as most of the channels are filtered out at the tap 51. Therefore the channel plan for that customer may indicate “High speed data only”, and the spectrum scan test at steps 101, 110 may generate the spectral scan data 103 and/or the set of signal indicators 113 based only on a subset of the all the channels on the cable system.

However, the signal health indicators computed based on a small number of channels may not be representative of the health of the node and therefore would not be used in the node scoring in some embodiments. In one embodiment, the tester 55 may transmit the spectral scan data 103 and/or the indicators 113 to CMC 7 for saving in the network test database 77 only for spectral scans including at least a pre-defined minimum number of channels, for example at least 6 or 10. In one embodiment, the spectral scan data 103 and/or the signal health indicators 113 for each spectral test are transmitted to CRC 7 and saved in the network test database therein, but the NMC 15 excludes test results with fewer than the pre-defined minimum number of channels, for example based on the channel plan identifier, when computing the node health score HS(node#).

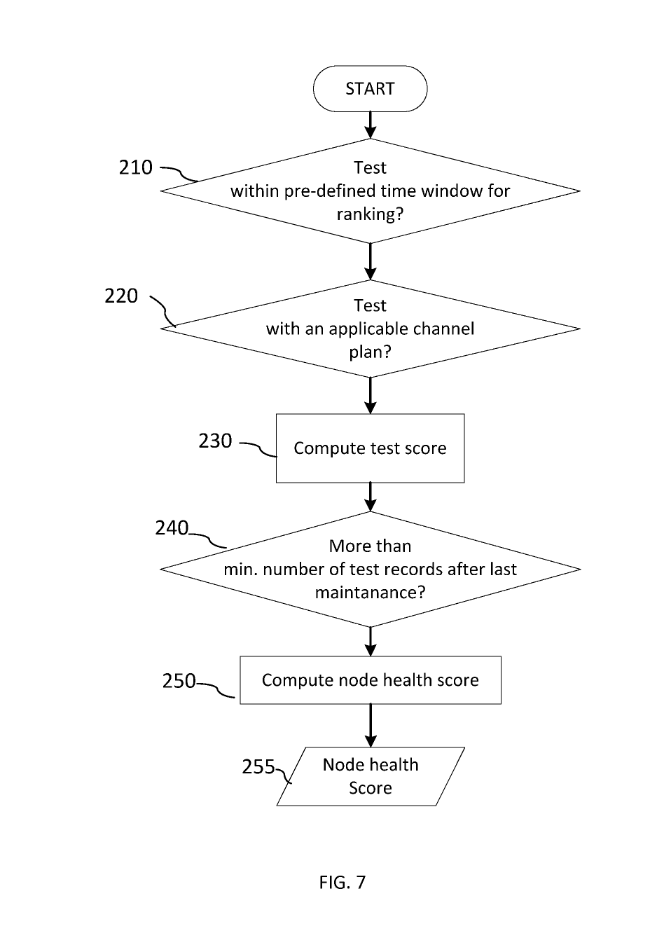

With reference to FIG. 7, in one embodiment the controller is configured, for example programmed, to perform one or more of the following checks when computing the test and health scores for a node. At step 210, the controller reading the test records 79 in the database 77 may check whether a test record was generated from a measurement performed within a pre-determine time window, for example within the last 6 months, so as to exclude old data that may become less relevant to the current state of the node. At step 220, the controller reading the test records 79 in the database 77 may check the channel plan corresponding to the test record, to ensure that the corresponding measurement was performed on a suitably large number of channels, for example at least 10, so as to exclude data where the results may be skewed due to a small number of channels. If both of the checks 210 and 220 are satisfied, a test score 230 is computed and/or the test record is identified as relevant for computing the node health score 255. At step 240, the controller checks if the total number of available test records 79 (wellness scores) for a node that satisfy the checks 210 and 220 is sufficient to compute a node health score. By way of example, the controller may compute the health score 255 at step 250 only for those nodes for which at least a minimum number, for example at least 3 or 5, of the test records 79 exists, or it may compute the health score 255 at step 250 with a warning that the score may be unreliable due to insufficient data. Here, the term ‘controller’ refers to one or both of CMC 7 and NMC 15, as either of them may be configured to perform one or more of the checks described hereinabove. Furthermore, some of the checks, e.g. with respect to the channel plan applicability, may be performed already at the stage of the measurement by the tester 55.

The above-described exemplary embodiments are intended to be illustrative in all respects, rather than restrictive, of the present invention. Thus the present invention is capable of many variations in detailed implementation that can be derived from the description contained herein by a person skilled in the art. For example, although the embodiment described hereinabove utilize a CATV tester device to collect spectral scan data, in other embodiments the scan data can be collected using suitably programmed measurement-capable cable modems installed at the subscriber premises. All such variations and modifications are considered to be within the scope and spirit of the present invention as defined by the following claims.

We claim:

1. A method for evaluating a node performance in a network, the method comprising:
a) measuring a network signal provided by the node and collecting spectral scan data therefore;
b) computing a set of signal health indicators from the collected spectral scan data;
c) comparing each signal health indicator to one or more predetermined threshold values; and,
d) computing a test score based on the set of signal health indicators for the node to evaluate the node performance at the time of the measurement.

2. The method of claim 1, wherein step c) comprises determining an indicator score for each signal health indicator from the computed set by comparing the signal health indicator to the one or more predetermined threshold values, and step (d) comprises computing the test score from the indicator scores.

3. The method of claim 1, further comprising:
e) repeating steps (a) to (d) at different times or at different locations in the network downstream from the node to obtain a plurality of the test scores for the node, and
f) computing a node health score based on the plurality of the test scores.

4. The method of claim 3, further comprising performing steps (a) to (f) for a plurality of network nodes to obtain a plurality of the node health scores, and ranking the plurality of the network nodes by comparing the node health scores thereof to determine a node maintenance priority.

5. The method of claim 1, wherein step (a) comprises performing tilt-normalization of the collected spectral scan data.

6. The method of claim 1, wherein the network signal comprises channels of different modulation type, and wherein step (a) comprises adjusting the collected spectral scan data in dependence on the modulation types of the channels.

7. The method of claim 3, wherein steps (a) to (d) are performed by a network tester connected to the network downstream from the node, and wherein step (d) further comprises sending the test score and/or the corresponding collected spectral scan data to one or more remote test servers for storing therein, for computing the node health score, and for ranking the nodes based on the node health scores.

8. The method of claim 1, wherein the set of signal health indicators comprises a maximum deviation indicator, a minimum deviation indicator, and a tilt compensation indicator.

9. The method of claim 8, wherein the set of signal health indicators further comprises a peak to valley difference indicator.

10. The method of claim 2, wherein step (c) comprises:
determining, for each of the signal indicators, whether the signal indicator is within a predetermined range; and,
for each signal indicator determined to be outside of the corresponding pre-determined range, reducing the node health score by a predefined value.

11. The method of claim 1, wherein step (c) comprises determining, for each of the signal health indicators, whether the signal health indicator is within a corresponding predetermined range, is below the lower threshold of the predetermined range, or exceeds the upper threshold of the predetermined range for the signal indicator.

12. The method of claim 3, wherein the node health score is computed based on the test scores measured downstream from the node within a pre-determined time interval.

13. The method of claim 2, further comprising:
obtaining a channel plan for the node, and verifying that the number of channels in the spectral scan data exceeds a pre-defined minimum number of channels;
wherein the step of computing the node health score comprises using only those test scores that were obtained from the spectral scan data with the number of channels exceeding the pre-defined minimum number of channels.

14. The method of claim 2, further comprising:
obtaining a channel plan for the node, and verifying that the number of channels in the channel plan exceeds a pre-defined minimum number of channels;
wherein step (b) of computing a set of signal health indicators from the collected spectral scan data is performed only if the number of channels in the network signal at the node exceeds the pre-defined minimum number of channels.
